(19) United States
(12) Patent Application Publication
(10) Pub. No.: US 2005/0113499 A1
(43) Pub. Date: May 26, 2005

(54) Low-emission aqueous dispersion adhesive

(76) Inventors: Thomas Tamcke, Dusseldorf (DE); Henk Rijsdijk, Heerhugoward (NL); Kari Honkanen, Oulo (FI)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/917,593

(22) Filed: Aug. 13, 2004

Related U.S. Application Data
(63) Continuation of application No. PCT/EP03/01387, filed on Feb. 12, 2003.

(30) Foreign Application Priority Data
Feb. 13, 2002 (DE) 102 05 893.8

(51) Int. Cl. C08L 1/00

(52) U.S. Cl. 524/270

(57) ABSTRACT

The invention is a low-emission dispersion adhesive based on polyacrylates with an addition of a tall oil resin modified by carboxy groups. The adhesive is distinguished by especially low emissions and otherwise its properties are equally as good, especially in terms of spreadability, initial tack and open time, as those of an adhesive containing balsam resin. The adhesive is very suitable for bonding floor coverings.

### CROSS-REFERENCE TO RELATED APPLICATIONS

This is a continuation application of PCT/EP03/01387, filed Feb. 12, 2003, which is incorporated herein by reference in its entirety, and also claims the benefit of German Priority Application No. 102 05 893.8, filed Feb. 13, 2002.

### FIELD OF THE INVENTION

The invention relates to a low-emission dispersion adhesive based on polymers with an addition of a tall oil resin modified by carboxy groups. The adhesive is distinguished by especially low emissions and otherwise its properties are substantially identical, especially in terms of spreadability, initial tack and open time, to the properties of adhesives containing proportions of high-boiling solvent components. The adhesive is very suitable for bonding floor coverings.

### BACKGROUND OF THE INVENTION

Dispersion adhesives and their use, especially in admixture with tackifier resins (tackifiers), are known. For example EP 0 490 191 A2 describes an adhesive composition that contains A) an aqueous acrylate adhesive and B) a mixture of a tackifier resin and a compound of the general formula R¹—O—(X—O)ₙ—R² wherein X represents an alkylene having from 2 to 4 carbon atoms, n is a integer from 1 to 8 and R¹ and R² are hydrogen or an aryl or alkaryl radical having from 6 to 12 carbon atoms, R¹ and R² not simultaneously being hydrogen.

In order to be able to utilize the tack of solid balsam resins in dispersion adhesives, the resins need to be brought into a liquid form. This can be achieved, for example, by dissolving the resins in aromatic solvents. Such resin solutions are then added, for example, to a polymer dispersion optionally already containing additives.

Modern solvent-free dispersion adhesives likewise contain balsam resins. In order that the emission behaviour of such adhesives is not adversely modified, so-called resin melts rather than resin solutions are added to the dispersion. To produce such resin melts, instead of low-boiling solvents there are used, for example, solvents having a boiling point of more than 200° C. With such resin mixtures consisting of resins and a plasticizer or a high-boiling solvent, the adhesives obtained are lower in emissions the lower the proportion of those substances in the adhesive and the higher the molecular weight of the plasticizer or of the high-boiling solvent. Since, however, the viscosity of such compositions is too high for the compositions to be incorporated into a polymer dispersion at room temperature, the compositions need to be heated before being added to the polymer dispersion.

If the preparation of adhesives having an extremely low emission value is desired, then the use of the above-mentioned high-boiling solvents is not sufficient. The only substances suitable for such a purpose are those having a boiling point higher than 300° C., preferably higher than 350° C. However such substances, for example the conventional plasticizers such as phthalates or benzoates, frequently have the disadvantage that the viscosity of the resin compositions is so high that the temperature for the incorporation into the adhesive likewise needs to be very high. Although the viscosity of the resin mixture can be reduced by increasing the proportion of plasticizer or of a high-boiling solvent, important properties of the adhesive produced therefrom are also seriously affected. For example the rheological properties (viscosity, spreadability) of the adhesive are adversely affected, and the open time is frequently shortened. In addition, the use of such resin melts appreciably reduces the tackifying action of the resin, with the result that the desired adhesive properties are often not achieved.

A further approach for solving the problem is based on the use of soft-resin esters, the addition of which lowers the viscosity of a corresponding resin composition. A problem that arises is that, owing to their low acid numbers, the resin esters are of poor compatibility with the polymer dispersion normally used. Adhesives prepared using such soft-resin esters therefore frequently have drawbacks in terms of stability and tack.

WO 98/56867 discloses a low-emission aqueous dispersion adhesive that contains polyacrylates, additions of tackifier resins, of plasticizers or of sparingly volatile high-boiling solvents, and optionally further additives. The described adhesive dispersions contain a resin mixture of balsam colophony and a carboxylated colophony soft-resin ester. Although the described adhesives have an excellent tack, they have disadvantages in other respects. A specific problem is that the raw material (balsam resin) required for the resin mixture may have very high emission values. If the emission values are to be lowered, the raw material has to be subjected to a process step in which readily volatile compounds are removed from the resin. That means additional expenditure, however, which is to be avoided both from the economic and the ecological standpoint.

Whereas balsam resin colophony is obtained by the so-called living resin formation of pines, for example in Portugal, China or Brazil, the chemically identical tall oil resin colophony is a by-product of paper manufacture. Tall oil resin colophony and balsam resin colophony differ, however, in respect of their contents. Compared with balsam resin colophony, tall oil resin colophony is chemically purer, is generally lower in emissions (due to the preparation steps involved in recovering it from waste wood) and is available in constant quality.

Frequent attempts have already been made to use tall oil resin colophony as an alternative to balsam resin colophony in dispersion adhesives. Owing to the purity of tall oil resin colophony, however, that raw material has a strong tendency to crystallise. This in turn leads to the resins having a reduced tack, with the result that the activity of a resin additive based on tall oil resin would not generally be adequate for higher requirements. Only a few fully esterified tall oil resins, for example tall oil resin glycerol esters, might be successful, but their use is substantially restricted because the compatibility of such resin esters with conventional polymer dispersions is limited, and accordingly the desired adhesive properties, for example the wet tack, are not adequate.

Starting from that prior art, the problem underlying the present invention was to reduce even further the emission values of a resin-containing adhesive without adversely affecting the other properties during preparation and processing and without adversely affecting the technical properties in terms of adhesion compared with adhesives containing balsam resins. This applies especially to the incorporation of the resin into a polymer dispersion, the viscosity and spreadability of the adhesive, the open time, the initial tack, the final tack and the thermal stability of the bond.

### SUMMARY OF THE INVENTION

It has now been found that the above problems can be solved by using a carboxylated tall oil resin as a tackifier resin.

The present invention accordingly relates to a low-emission aqueous dispersion adhesive, the dispersion adhesive comprising a carboxylated tall oil resin.

In addition to comprising at least one carboxylated tall oil resin, a dispersion adhesive according to the invention comprises an aqueous dispersion of a polymer or of a mixture of two or more polymers.

### DETAILED DESCRIPTION OF THE PREFERRED EMBODIMENTS

The polymer or mixture of two or more polymers are preferably free-radical-polymerised polymers such as can be obtained from ethylenically unsaturated monomers.

The polymer preferably contains so-called main monomers selected from C₁-C₂₀alkyl(meth)acrylates, vinyl esters of carboxylic acids containing up to 20 carbon atoms, vinyl aromatic compounds containing up to 20 carbon atoms, ethylenically unsaturated nitriles, vinyl halides, non-aromatic hydrocarbons having at least 2 conjugated double bonds, or mixtures of such monomers.

The monomers mentioned above and mixtures of those monomers are preferably present in the polymer in an amount of from 60 to 100% by weight, especially from 80 to 100% by weight, more especially from 90 to 99.8% by weight, based on the polymer.

There may be mentioned specifically, for example, acrylic acid alkyl esters or methacrylic acid esters having a C₁-C₁₂alkyl radical, such as methyl methacrylate, methyl acrylate, n-butyl acrylate, ethyl acrylate and 2-ethylhexyl acrylate. There are especially also suitable polymers that can be obtained by polymerisation of mixtures of acrylic acid alkyl esters and (meth)acrylic acid alkyl esters.

For the preparation of suitable polymers there are also suitable, for example, the vinyl esters of carboxylic acids containing from 1 to 20 carbon atoms. For the preparation of suitable polymers there are suitable, for example, vinyl laurate, vinyl stearate, vinyl propionate, versatic acid vinyl ester or vinyl acetate, or mixtures of two or more thereof.

Suitable vinyl aromatic compounds include, for example, vinyltoluene, α- and p-methylstyrene, α-butylstyrene, 4-n-butylstyrene, 4-n-decylstyrene and styrene. Acrylonitrile and methacrylonitrile are examples of suitable nitriles.

Likewise suitable for the preparation of suitable polymers are vinyl halides, for example ethylenically unsaturated compounds substituted by chlorine, fluorine or bromine, such as vinyl chloride or vinylidene chloride or mixtures thereof.

For the preparation of suitable polymers there are furthermore suitable non-aromatic hydrocarbons containing from 2 to 8 carbon atoms and at least two olefinic double bonds, such as butadiene, isoprene and chloroprene.

Further monomers that may be present in the polymer in an amount of, for example, from 0 to 40% by weight, especially from 0 to 20% by weight and more especially from 0.2 to 10% by weight, are especially C₁-C₁₀hydroxyalkyl (meth)acrylates, (meth)acrylamide and derivatives thereof substituted on the nitrogen by C₁-C₄alkyl, ethylenically unsaturated carboxylic acids, dicarboxylic acids, their semi-esters and anhydrides, for example (meth)acrylic acid, maleic acid, fumaric acid, maleic acid anhydride, maleic acid and fumaric acid semi-esters and itaconic acid.

The glass transition temperature of suitable polymers is preferably from −50 to −10° C., for example from −40° C. to −15° C. or from −15 to −30° C.

The glass transition temperature of the polymer can be determined by conventional methods, such as differential thermoanalysis or differential scanning calorimetry (see e.g. ASTM 3418/82, so-called “midpoint temperature”).

The number average (Mₙ) of the molecular weight of the soluble components of suitable polymers is, for example, lower than 30,000 or lower than 20,000, for example lower than 15,000, the weight average (M_{W}) of the molecular weight being, for example, higher than 250,000 (determined by gel permeation chromatography using polystyrene as standard in a polymer solution in tetrahydrofuran after sedimentation of the insoluble components).

However, Mₙ is generally not below 5000 g/mol and M_{W} is generally not above 800,000 g/mol.

The polymer is prepared, for example, by free-radical polymerisation. Suitable polymerisation methods, such as substance, solution, suspension or emulsion polymerisation, are known to the person skilled in the art.

Preferably, the copolymer is obtained by solution polymerisation with subsequent dispersion in water or, especially, by emulsion polymerisation, so that aqueous polymer dispersions are obtained.

The emulsion polymerisation can be carried out discontinuously, with or without the use of seed latices, with the initial provision of all or of individual components of the reaction mixture, or preferably with partial initial provision of and subsequent addition of the components or of individual components of the reaction mixture, or by the addition process without any initial provision.

In the emulsion polymerisation procedure the monomers may be polymerised in the usual manner in the presence of a water-soluble initiator and an emulsifier at preferably from 30 to 95° C.

Suitable initiators include, for example, sodium persulphate, potassium persulphate and ammonium persulphate, tert.-butyl hydroperoxides, water-soluble azo compounds or also redox initiators, such as H₂O₂/ascorbic acid.

The emulsifiers used are, for example, alkali metal salts of longer-chained fatty acids, alkyl sulphates, alkyl sulphonates, alkylated aryl sulphonates or alkylated biphenyl ether sulphonates. Emulsifiers that also come into consideration are reaction products of alkylene oxides, especially ethylene or propylene oxide, with fatty alcohols, fatty acids or phenol, or alkylphenols.

In the case of aqueous secondary dispersions, the copolymer is first prepared by solution polymerisation in an organic solvent and then, with the addition of salt formers, for example ammonia, dispersed in water, without the use of an emulsifier or dispersing adjuvant, to form carboxylic acid-group-containing copolymers. The organic solvent can be distilled off. The preparation of aqueous secondary dispersions is known to the person skilled in the art and is described, for example, in DE-A-37 20 860.

To adjust the molecular weight, regulators may be added during the polymerisation procedure. Suitable regulators include, for example, —SH-containing compounds, such as mercaptoethanol, mercaptopropanol, thiophenol, thioglycerol, thioglycolic acid ethyl ester, thioglycolic acid methyl ester and tert-dodecylmercaptan.

The solids content of the resulting polymer dispersions is preferably from 40 to 80% by weight, especially from 45 to 75% by weight. High contents of polymer-solids can be adjusted, for example, according to processes described in German Patent Application P 4 307 683.1 or in EP 37 923.

Polyacrylate dispersions especially suitable in accordance with the invention are described, for example, in EP 0 490 191 A2. Reference is made expressly to that specification, and its disclosure content in respect of aqueous polymer dispersions is considered to be a component of the disclosure of the present text. Accordingly the polyacrylate consists for the most part of acrylates and/or methacrylates of alcohols containing from 1 to 24 carbon atoms. There are generally more than 25% by weight of those monomer building blocks in the polyacrylate. Further monomer building blocks include, for example: vinyl esters and allyl esters of carboxylic acids containing from 1 to 20 carbon atoms, vinyl ethers of alcohols containing from 1 to 8 carbon atoms, vinyl aromatic compounds, vinyl halides, non-aromatic hydrocarbons containing from 2 to 8 carbon atoms and at least one olefinic double bond, α,β-unsaturated mono- or di-carboxylic acids containing from 3 to 6 carbon atoms and derivatives thereof (especially amides, esters and salts). The proportions by weight of the monomer building blocks are so selected that the polyacrylate has a glass transition temperature of from −60 to 0° C., preferably from −50 to −10° C. For further details, and especially for the preparation of aqueous polyacrylate dispersions, reference is made to EP 0 490 191 A2 or DE 198 01 892 A1.

In the context of the present invention, however, it is also possible to use polyacrylate dispersions according to EP 0 620 243.

The solids content of the aqueous polyacrylate dispersions is preferably in the range from 40 to 65% by weight measured according to DIN 53189.

Suitable commercially available dispersions are, for example Arconal® A323, Arconal® A 378, Arconal® A 380 (manufacturer: BASF), Airflex® EAF 60, Airflex® EAF 67 (manufacturer: APP), Mowilith® DM 1340 (manufacturer: Clariant), Primal® CA 162 or Primal® CA 172 (manufacturer: Rohm & Haas).

The carboxylated tall oil resin colophony described according to the invention is a modified tall oil resin. At 40° C. it has a dynamic viscosity of from 10 to 80 Pa*s according to DIN 53214. The carboxylated tall oil resin colophony has an acid number in the range from 10 to 140 mg KOH/g, preferably from 110 to 130 mg KOH/g, according to DIN 53402 or a softening point (Ring and Ball) of from about 35 to about 70° C., especially from about 40 to about 70° C., especially from about 50 to about 60° C. The resin ester may be either saturated or unsaturated.

The partially esterified colophony soft-resin ester can be obtained, for example, by esterification of tall oil resin colophony having an acid number of from about 160 to 180 mg KOH/g and a content of free resin acids of from about 80 to about 95% by weight by diols such as di- or tri-ethylene glycol, with subsequent partial esterification of the OH groups by acid anhydrides, such as, for example, maleic acid anhydride.

In the context of a preferred embodiment of the present invention, however, a carboxylated tall oil resin colophony is used which can be obtained according to a new multi-step process.

The present invention accordingly relates to a process for the preparation of a carboxylated tall oil resin derivative, the preparation being carried out in a plurality of steps wherein:
a) in a first step a tall oil resin is reacted with an olefinically unsaturated carboxylic acid,
b) in a further step a disproportionation agent is added,
c) in a further step a polyol is added, and
d) in a further step a neutralising agent is added.

In that process, for example first of all, in a first step, the resin is brought to a temperature of from about 120 to about 280° C. in an inert atmosphere. An unsaturated carboxylic acid or an anhydride of an unsaturated carboxylic acid is then added to the heated resin. The acid is preferably added at a temperature of from about 180 to about 250° C., especially from about 200 to about 240° C. or from about 210 to about 230° C. The reaction between the unsaturated carboxylic acid or a mixture or two or more unsaturated carboxylic acids or an anhydride of an unsaturated carboxylic acid or a mixture of two or more anhydrides of unsaturated carboxylic acids should be continued for a period of from about 20 to about 150 minutes or from about 30 to about 120 minutes, especially from about 40 to about 90 minutes.

In a second step, the reaction mixture is then cooled, for example to a temperature of from about 120 to about 190° C., for example from about 130 to about 180° C. or from about 140 to about 160° C. When the desired temperature is reached, a disproportionation agent is added. The reaction mixture is maintained at that temperature for a period of about 10 to about 80 minutes or about 10 to about 60 minutes, especially for about 20 to about 40 minutes.

In a third step, the reaction mixture is brought, for example, to a temperature of from about 230 to about 280° C., especially to a temperature of from about 245 to about 255° C., and a polyol is added to the reaction mixture for the esterification. The duration of the esterification reaction should be from about 40 to about 200 minutes, for example from about 60 to about 180 minutes, especially from about 90 to about 120 minutes.

In a fourth step, the reaction mixture is brought, for example, to a temperature of from about 200 to about 240° C., especially about 210 to about 230° C., and a neutralising agent is added to the reaction mixture. The reaction mixture treated in that manner is maintained at the set temperature for a period of from about 30 to about 100 minutes, especially about 50 to about 70 minutes, and is then worked up.

Unsaturated carboxylic acids suitable in the context of the present invention are in principle any mono- or poly-carboxylic acids having at least one olefinically unsaturated double bond. The unsaturated carboxylic acids preferably used, however, are those having a maximum of about 12 carbon atoms, especially olefinically unsaturated carboxylic acids having from about 4 to about 10 carbon atoms. In the context of a further preferred embodiment of the present invention, the unsaturated carboxylic acids are dicarboxylic acids, especially maleic acid or fumaric acid or a mixture thereof. The amount of unsaturated carboxylic acids is from about 1 to about 10% by weight, especially from about 2 to about 8% by weight or from about 3 to about 5% by weight, based on the tall oil resin used.

Suitable disproportionation agents are in principle any compounds by means of which the reaction between tall oil resin and carboxylic acid or between tall oil resin and carboxylic acid mixture can be interrupted. Compounds that are especially suitable are those that are able to capture free radicals. In the context of the present invention, such compounds can be added individually or in the form of a mixture of two or more suitable compounds. In the context of a preferred embodiment of the present invention, sterically hindered aromatic phenols are added as disproportionation agents. In the context of an especially preferred embodiment of the present invention, 4,4′-thiobis(3-methyl-6-tert-butylphenol) is added as disproportionation agent, together with iodine. In the context of the present invention, suitable disproportionation agents are added in an amount of from about 0.01 to about 1% by weight, especially in an amount of from about 0.05 to about 0.5% by weight. Additives that assist in the interruption of the reaction, for example iodine, are preferably added in an amount of from about 0.01 to about 1% by weight, especially in an amount of from about 0.08 to about 0.5% by weight, for example from about 0.1 to about 0.3% by weight, based on the amount of tall oil resin used.

Polyols suitable in the context of the present invention are in principle any compounds that contain two or more OH groups. Of those, polyols having a molecular weight of less than about 500, especially less than about 300, are especially suitable. Of those, the following are especially suitable: ethylene glycol, diethylene glycol, triethylene glycol, 1,2-propanediol, dipropylene glycol, the isomers of butanediol, hexanediol and octanediol, commercial mixtures of hydroxy fatty alcohols containing from 14 to 22 carbon atoms, trimethylolpropane or glycerol or mixtures of two or more of the mentioned polyols. The polyols are added to the reaction mixture in an amount of from about 0.5 to about 10% by weight, for example in an amount of from about 1 to about 7% by weight or from about 2 to about 4% by weight, based on the amount of tall oil resin used.

Suitable neutralising agents are in principle any compounds that enter into a neutralisation reaction, in the sense of an acid/base reaction, with the carboxyl groups in the tall oil resin derivative. There are suitable, for example, inorganic bases, such as the oxides or hydroxides of alkali metals or alkaline earth metals, especially of alkali metals, for example LiOH, NaOH or KOH.

Further suitable neutralising agents are amines that can be reacted with protonation with a carboxy group. Suitable amines include, for example, primary, secondary or tertiary amines that may in addition contain one or more functional groups. Especially suitable are amines such as trimethylamine, triethylamine or higher homologues thereof or amines that contain one or more OH functionalities, for example ethanolamine, diethanolamine or especially triethanolamine. The neutralising agents are used in an amount that is sufficient for the reaction product to be mixed in the desired state of neutralisation. Preferably, the amount of neutralising agents is from about 0.5 to about 5% by weight or from about 1 to about 3% by weight, based on the amount of tall oil resin used.

The tall oil resin derivatives that can be prepared in that manner have a property profile that allows them to be used as tackifiers in dispersion adhesives. The present invention accordingly relates also to tall oil resin derivatives that can be prepared according to a process of the invention.

To prepare a dispersion adhesive according to the invention, the above-mentioned tall oil resin derivatives are incorporated into a polymer dispersion. As already explained at the outset in the present text, with a view to the emission values of the resulting adhesive, the resin composition used in the case according to the invention comprises a tall oil resin derivative according to the invention or a mixture of two or more tall oil resin derivatives according to the invention, as described hereinabove, and at least one further additive for the preparation of a suitable resin composition.

Typical additives include: colophony resin esters, for example balsam colophony esters or tall oil resin esters, plasticizers or high-boiling solvents or mixtures of two or more thereof.

The present invention accordingly relates also to a resin composition that comprises at least a tall oil resin derivative according to the invention and one further additive.

In that case a resin composition according to the invention contains at least about 30% by weight of a tall oil resin derivative according to the invention or of a mixture of two or more tall oil resin derivatives according to the invention. The upper limit for the content of a tall oil resin derivative according to the invention or of a mixture of two or more tall oil resin derivatives according to the invention in the resin composition according to the invention is about 85% by weight, especially about 80 or about 75% by weight. Preferably, a resin composition according to the invention contains from about 40 to about 60% by weight of tall oil resin derivative according to the invention or of a mixture of two or more tall oil resin derivatives according to the invention.

The colophony ester used may be, for example, partially esterified balsam resin or partially esterified tall oil resin. Suitable colophony soft-resin esters may, for example, be carboxylated. Suitable compounds are described, for example, in WO 98/56867 on pages 4-5, the preparation processes and compounds described therein being considered as a component of the disclosure of the present text. The content of colophony soft-resin ester or of a mixture of two or more colophony soft-resin esters in a resin composition according to the invention is from about 0 to about 60% by weight, especially about 30 to about 55% by weight.

Plasticizers suitable in the context of the present invention are according to DIN 55945 liquid or solid inert organic substances having low vapour pressure. On account of their dissolving and swelling capacities, they reduce the hardness of the polymer and increase its adhesive power.

Suitable as high-boiling solvents are inert compounds having a boiling point in the range from 200 to 300° C. Phenoxyethanol, phenoxypropanol and butyl diglycol acetate, for example, are especially suitable.

Suitable plasticizers are, for example, the ethers mentioned in the introduction to the description of EP 0 490 191.

The plasticizers preferably used are adipic and sebacic acid plasticizers, phosphoric acid plasticizers, citric acid plasticizers, fatty acid esters and epoxidised fatty acid esters, fatty alcohols, polypropylene glycol, polyethylene glycol, benzoates or phthalates or mixtures of two or more thereof.

Especially suitable in the context of the present invention are aromatic plasticizers having a boiling temperature at normal pressure of more than 250° C., preferably more than 300° C. and especially more than 350° C.

Suitable fatty acid esters are in principle any fatty acids esters that meet the above-mentioned specifications in respect of the boiling point. Especially suitable, for example, are the alkyl esters of fatty acids containing more than about 14 or more than about 16 carbon atoms, for example the alkyl esters of lauric, myristic, stearic, arachidic and behenic acid and mixtures thereof, such as are obtainable from natural fats or hydrogenated oils, such as tallow or hydrogenated palm oil.

The alcohol moiety of the carboxylic acid esters contains a mono- or poly-hydric alcohol containing from 1 to 28 carbon atoms in the hydrocarbon chain. Examples of suitable alcohols are methanol, ethanol, isopropanol, butanol, 2-ethylhexanol, vinyl alcohol, erythritol and pentaerythritol. Preferred esters are those of methanol, ethanol and isopropanol, the acid moiety of the ester being selected especially from behenic acid, stearic acid, oleic acid, palmitic acid or myristic acid.

Suitable as fatty alcohols are the alcohols of the above-mentioned fatty acids, such as are obtainable from the fatty acids or esters thereof by processes known to the person skilled in the art.

The content of fatty acid esters, epoxidised fatty acid esters or fatty alcohols or mixtures of two or more thereof in the resin composition according to the invention is in total from about 0 to about 30% by weight, especially from about 0 to about 15% by weight.

In the context of the present invention there are suitable as additives especially plasticizers and high-boiling solvents such as dioctyl phthalate, diisononyl phthalate, diisodecyl phthalate, phthalic acid esters containing predominantly linear C₆ to C₁₂alcohols, dibutyl phthalate, diisobutyl phthalate, dicyclohexyl phthalate, dimethyl phthalate, diethyl phthalate and mixed esters of benzyl-butyl phthalate, butyl-octyl phthalate, butyl-decyl phthalate and dipentyl phthalate, dimethyl glycol phthalate, dicapryl phthalate, diethylene glycol benzoate and dipropylene glycol dibenzoate or mixtures of two or more thereof.

The content of plasticizers or high-boiling solvents or mixtures of two or more thereof in a resin composition according to the invention is in total from about 0 to about 30% by weight, especially from about 0 to about 15% by weight.

In the context of the present invention, the content of adhesives according to the invention in a resin composition according to the invention is from about 1 to about 40% by weight, for example from about 5 to about 30% by weight or from about 10 to about 25% by weight.

The proportion of adhesive according to the invention in the polymer dispersion is from about 10 to about 99% by weight, the solids content of the polymer dispersion lying within the above-mentioned limits.

An adhesive according to the invention may furthermore contain film-forming adjuvants, preservatives, anti-foams, thickeners or fillers or mixtures of two or more thereof.

In the context of a further embodiment of the present invention, as fillers there come into consideration, for example, carbonates (especially calcium carbonate), quartz powder, silicates (for example talc, clay, mica), siliceous earth, sulphates such as calcium or barium sulphate or aluminium hydroxide. Such fillers may be present in the water-soluble composition according to the invention in an amount of, for example, up to about 60% by weight, preferably from about 15 to about 55% by weight or from about 20 to about 50% by weight, based on the total dispersion adhesive.

The fillers are preferably finely ground fillers, especially chalk, having an average particle diameter of generally from 2 to 10 μm. Quartz powder is used preferably with an average diameter of from 3 to 20 μm.

Suitable anti-foams are preferably compounds based on mineral oils or silicones. There are used as thickeners preferably compounds that are based on (meth)acrylic acid (co)polymers or cellulose derivatives or mixtures thereof. Suitable as preservatives are customary preservatives, for example benzisothiazolinone (BIT), chloromethyl isothiazolinone (CMIT) and the like.

In the context of a preferred embodiment of the present invention, a dispersion adhesive according to the invention contains from 20 to 60% by weight of an aqueous polymer dispersion, from 1 to 15% by weight of a carboxylated tall oil resin colophony and from 15 to 55% by weight of fillers.

In an adhesive according to the invention there may be present, in addition, anionic, cationic or ampholytic surfactants, or mixtures of two or more thereof. Examples of suitable anionic surfactants are alkyl sulphates, especially those having a chain length of from about 8 to about 18 carbon atoms, alkyl and alkaryl ether sulphates containing from about 8 to about 18 carbon atoms in the hydrophobic moiety and from 1 to about 10 ethylene oxide (EO) or propylene oxide (PO) units, or a mixture thereof, in the hydrophilic moiety of the molecule, sulphonates, especially alkyl sulphonates, containing from about 8 to about 18 carbon atoms, alkylaryl sulphonates containing from about 8 to about 18 carbon atoms, taurides, esters and semi-esters of sulphosuccinic acids with monohydric alcohols or alkylphenols containing from 4 to about 15 carbon atoms, which may be ethoxylated by from 1 to about 20 EO units, alkali metal and ammonium salts of carboxylic acids, for example of fatty acids or resin acids containing from about 8 to about 32 carbon atoms or mixtures thereof, phosphoric acid partial esters and alkali metal and ammonium salts.

Examples of cationic surfactants are salts of primary, secondary or tertiary fatty amines containing from about 8 to about 24 carbon atoms with acetic acid, sulphuric acid, hydrochloric acid or phosphorus acids, quaternary alkyl- and alkylbenzeneammonium salts, especially those in which the alkyl groups contain from about 6 to about 24 carbon atoms, especially the halides, sulphates, phosphates or acetates, or mixtures of two or more thereof, alkylpyridinium, alkylimidazolinium or alkyloxazolidinium salts, especially those in which the alkyl chain contains up to about 18 carbon atoms, for example the halides, sulphates, phosphates or acetates, or mixtures of two or more thereof.

Examples of ampholytic surfactants are long-chain-substituted amino acids, such as N-alkyl-di(aminoethyl)glycine, or N-alkyl-2-aminopropionic acid salts, betaines, such as N-(3-acylamidopropyl)-N,N-dimethylammonium salts having a C₈₋₁₈ acyl radical or alkylimidazolium betaines.

In a preferred embodiment of the present invention, an adhesive according to the invention contains anionic surfactants. Alkali metal salts are especially suitable, especially the sodium salt of C_{12/14} fatty alcohol ether sulphates, alkylphenol ether sulphates, especially the alkali metal or NH₄ salts thereof, sodium n-dodecylsulphate, dipotassium oleic acid sulphonate (C₁₈), sodium n-alkyl-(C₁₀C₁₃)benzenesulphonate, sodium 2-ethylhexyl sulphate, NH₄ lauryl sulphate (C_{8/14}), sodium lauryl sulphate (C_{12/14}), sodium lauryl sulphate (C_{12/16}), sodium lauryl sulphate (C_{12/18}), sodium cetyl stearyl sulphate (C_{16/18}), sodium oleyl cetyl sulphate (C_{16/18}), sulphosuccinic acid monoester disodium salt, fatty alcohol sulphosuccinate disodium salt, dialkylsulphosuccinate sodium salt or disodium sulphosuccinamate or mixtures of two or more thereof.

When an adhesive according to the invention contains ionic surfactants, then in a preferred embodiment of the invention those surfactants are present in an amount of up to about 5% by weight or less, for example up to about 2% by weight or about 1% by weight or less, based on the total adhesive. If desired, even smaller amounts of ionic surfactant may be present, for example up to about 0.5% by weight or below, for example about 0.2% by weight, 0.1% by weight or 0.05% by weight.

In a further embodiment of the present invention, an adhesive according to the invention may comprise at least one non-ionic surfactant. Examples of suitable non-ionic surfactants are alkyl polyglycol ethers, preferably those having from about 8 to about 20 EO units and alkyl radicals containing from about 8 to about 20 carbon atoms, alkylaryl polyglycol ethers, preferably those having from about 8 to about 40 EO units and from about 8 to about 20 carbon atoms in the alkyl or aryl radicals, ethylene oxide/propylene oxide (EO/PO) block copolymers, preferably those having from about 8 to about 40 EO and PO units, addition products of alkylamines having alkyl radicals containing from about 8 to about 22 carbon atoms with ethylene oxide or propylene oxide, fatty acids and resin acids containing from about 6 to about 32 carbon atoms, alkyl polyglycosides having linear or branched, saturated or unsaturated alkyl radicals containing on average from about 8 to about 24 carbon atoms and having an oligoglycoside radical containing on average from about 1 to about 10 hexose or pentose units, or mixtures of two or more thereof, natural substances and derivatives thereof, such as lecithin, lanolin or sarcosine, polar-group-containing linear organo(poly)siloxanes, especially those having alkoxy groups containing up to about 10 carbon atoms and up to about 20 EO or PO groups.

Further suitable non-ionic surfactants include, for example, nonylphenol ethoxylates, octylphenol ethoxylates, C_{12/14}-fatty alcohol ethoxylates, oleyl cetyl ethoxylates, C_{16/18}-fatty alcohol ethoxylates, cetyl stearyl ethoxylates, ethoxylated triglycerides, sorbitan monolaurate, sorbitan monooleate, sorbitan-20EO-monooleate, sorbitan-20EO-monostearate or mixtures of two or more thereof.

When the adhesive according to the invention comprises non-ionic surfactants, such surfactants are present preferably in a maximum amount of up to about 5% by weight or less, for example up to about 2% by weight or about 1% by weight, or less, based on the total adhesive. If desired, even smaller amounts of non-ionic surfactant may be present, for example up to about 0.5% by weight or below, for example about 0.2% by weight, 0.1% by weight or 0.05% by weight.

To prepare the adhesives according to the invention, for example from 5 to 25, preferably from 10 to 20, parts by weight of a resin composition according to the invention are mixed with from 10 to 60, preferably from 15 to 45, parts by weight of aqueous polymer dispersion, preferably having a solids content of from 55 to 65% by weight, and with from 15 to 55, preferably from 20 to 50, parts by weight of fillers. The other possible additives play a subordinate role in terms of weight. The components can be processed without problems, under the customary conditions (especially at temperatures of from 70 to 80° C.) to form the aqueous dispersion adhesive according to the invention.

The present invention accordingly relates also to a process for the preparation of adhesives according to the invention in which a carboxylated tall oil resin colophony derivative is mixed with an aqueous dispersion of a polymer. In the context of a preferred embodiment of the present invention, the carboxylated tall oil resin colophony derivative in the form of a resin composition according to the invention is mixed with the aqueous dispersion of a polymer.

Generally, the dispersion adhesive according to the invention is prepared as follows: the aqueous polyacrylate dispersion is placed in a stirring vessel at from 10 to 90° C. and additives such as anti-foams, preservatives, thickeners, emulsifiers and water and also the filler are added with stirring. Then, with vigorous stirring, the resin composition according to the invention, heated to from 70 to 100° C., is added in portions or continuously. Finally, the viscosity is regulated by the addition of thickener or water.

The dispersion adhesive according to the invention is suitable especially as an adhesive for bonding substrates of plastics, wood, metal and textiles of woven and or non-woven fibres. It is suitable especially as a floor adhesive, especially for bonding floor coverings to substrates of wood or plastics, or especially mineral substrates, such as plaster flooring, concrete, cement levelling compositions or gypsum-based levelling compositions or ceramic floor tiles.

More especially, the adhesive according to the invention is suitable as a floor adhesive for carpeting or other floor coverings, for example of PVC (in constructions in the form multi-layer coverings or homogeneous coverings) foamed plastics coverings having a textile backing (e.g. jute), polyester fleece, rubber coverings, textile coverings, for example also with various backing finishes (such as polyurethane foam, styrene-butadiene foam, textile secondary backings), needled felt floor coverings, polyolefin coverings or linoleum coverings, on substrates such as wood, plaster flooring, concrete, ceramic floor tiles, metal substrates, cement levelling compositions or gypsum-based levelling compositions or ceramic floor tiles or the like.

The adhesive according to the invention can be applied to the substrate using, for example, a toothed strip. After the customary airing, the floor covering is laid. The adhesive according to the invention has a good level of technical properties in use, such as peel resistance, shear strength, wet attraction power, dry holding power and heat resistance.

The polyacrylate-based aqueous dispersion adhesive according to the invention should meet various requirements according to the field of use. For bonding floor coverings, the following characteristic data are of importance: the viscosity according to Brookfield HBT, spindle 4, 20 revs/min (IS02555) should be more than 15,000, preferably more than 18,000 up to a max. of about 40,000, especially from about 20,000 to about 30,0000 mPa*s.

The initial tack should be more than a rating of 3, preferably more than a rating of 2.

The open time should be more than 15 minutes, preferably more that 20 minutes up to a maximum of 40 minutes. An open time of less than 10 minutes is designated as inadequate.

The dispersion adhesives according to the invention meet those requirements and are furthermore distinguished by a good spreadability (rheology) and unusually high end strengths. In addition, they are appreciably lower in emissions, which can also be observed in the noticeably reduced odour and is determinable especially in suitable test chambers.

Given its excellent properties, the adhesive according to the invention is especially well suited to bonding floor coverings. For that purpose it is applied to the substrate using, for example, a toothed strip. After the customary airing, the floor covering is laid.

The invention is now explained in detail by way of the following examples.

### EXAMPLES

1. Preparation of a Carboxylated Tall Oil Resin Colophony

1000 g of tall oil resin (melting point: 66° C., acid number: 168 mg KOH/g) were heated to 200° C. and then 40 g of fumaric acid were added to the melt. The reaction mixture so obtained was heated further to a temperature of 215° C. and maintained at that temperature for a period of 80 minutes. Subsequently, the reaction mixture was cooled to a temperature of 155° C. and 1 g of 4,4′-thiobis(3-methyl-6-tert-butylphenol) and 2 g of iodine were added. The reaction mixture was left at the latter temperature for a period of 30 minutes and then heated to a temperature of 250° C. At that temperature, 30 g of glycerol were added and the reaction mixture was maintained at that temperature for a period of 110 minutes. The reaction mixture was then cooled to a temperature of 215° C. and 20 g of triethanolamine were added. After 60 minutes at 215° C., the product was removed from the reaction vessel without further working up. The reaction product had a softening point of 50° C. and an acid number of 115 mg KOH/g.

2a. Basic Recipe for a Resin Composition According to the Invention

| | | |
|---|---|---|
| i) | plasticizer | 15% by weight |
| ii) | carboxylated tall oil resin colophony from | 50% by weight |
| | Example 1 | |
| iii) | tall oil resin-triethylene glycol ester | 35% by weight |

2b. Preparation of a Resin Composition According to the Invention

The plasticizer was introduced into a stirring vessel and heated to 90° C. The carboxylated tall oil resin colophony, heated to 90° C., was then added with stirring. The tall oil resin-triethylene glycol ester, heated to 60° C., was then added to the resulting mixture, and the whole was homogenised by stirring for a further 20 minutes at 90° C.

3. Basic Recipe for a Water-Based PVC-Covering Adhesive

TABLE 1

| | | Amount |
|---|---|---|
| No. | Component | (% by wt) |
| 1. | Butyl acrylate copolymer dispersion having a solids | 28.3 |
| | concentration of 62% by weight | |
| 2. | Anti-foam, silicone base | 0.04 |
| 3. | Preservative, Kathon | 0.10 |
| 4. | Thickener (hydroxyethyl cellulose type) | 0.20 |
| 5. | Emulsifier (fatty alcohol polyglycol ether type) | 1.00 |
| 6. | Water | 6.00 |
| 7. | Polypropylene glycol, molecular weight 1000 | 2.00 |
| 8. | Chalk, amorphous (0-50 μm) | 29.40 |
| 9. | Chalk, crystalline (0-20 μm) | 13.20 |
| 10. | Resin composition (2b) | 13.90 |
| 11. | Thickener (polyacrylic acid type) | 0.50 |
| 12. | Water | 5.36 |

To prepare an adhesive according to the invention, 1 (No from Table 1) was introduced into a mixing vessel and stirred. Then, with stirring, 2 and 3 were added and the mixture was homogenised. 4 was mixed with 5 in a separate container and then added to the mixing vessel. The mixture was carefully stirred around the mixing vessel. 6, 7, 8 and 9 were then added and the mixture was stirred until smooth. Subsequently, with vigorous stirring, the resin composition 10 heated to 80° C. was added, and the batch was homogenised and 11 was added. The viscosity was adjusted by the final addition of 12.

A floor adhesive according to WO 98/56867 (Example 2a) was used for comparison purposes.

TABLE 2

| | | | | | According to the | |
|---|---|---|---|---|---|---|
| | Comparison Example 1 | | Comparison Example 2 | | Invention | |
| Type of resin | Resin mixture from | | Resin composition from | | Resin mixture with | |
| composition | WO 98/56867 | | DE19831000C1 | | carboxylated tall oil resin | |
| VOC content | >0.2% by weight | | >0.1% by weight | | <0.1% by weight | |
| Use in floor | PVC | Textile | PVC | Textile | PVC | Textile |
| adhesive for: | coverings | coverings | coverings | coverings | coverings | coverings |
| Incorporability | good | good | good | good | good | good |
| Spreadability/ | good | good | good | good | good | good |
| rheology | | | | | | |
| Wet tack | very good | good | very good | very good | good | good |
| Open time | good | good | moderately | good | good | good |
| | | | good | | | |
| Peel resistance | good | good | | | good | very good |
| (EN 1372) | | | | | | |
| Shear strength | very good | very good | poor | moderate | good | very good |
| (EN 1373) | | | | | | |
| Resin odour | noticeable | noticeable | noticeable | noticeable | very faint | very faint |

4. Test Method Description

Incorporability of the Resin Melt, Spreadability

The parameters are evaluated subjectively by a rating system of from 1 down to 5 in the laboratory tests and are confirmed by practical test.

Tack/Open Time Method Description:

The adhesive to be tested is applied, using a toothed strip A3 (adhesive grooves transverse to the longitudinal direction of the panel), to a precoated chipboard panel (1000×180×10 mm) that has been smoothed using a cement levelling composition, and the stopwatch is started.

After 10 minutes and at further intervals of 5 minutes, in each case a strip of PVC covering (200×45 mm) is laid in the adhesive and rolled using a 3.5 kg pressure roller.

The covering is then immediately peeled off again manually and the wet tack is evaluated by a rating system of from 1 down to 5. In addition, the wetting of the back of the covering with adhesive is recorded.

The maximum tack achieved during the test as a whole is noted.

The end of the open time is clearly recognisable by the appreciable decline in the wetting. In the case of good PVC-covering adhesives, an open time of about 30 minutes is expected. An open time below 15 minutes is designated as inadequate.

1. A low-emission aqueous dispersion adhesive, comprising;
an aqueous polymer dispersion comprising water and a water-dispersible polymer; and
a carboxylated tall oil resin colophony.

2. The dispersion adhesive according to claim 1, comprising from 20 to 60% by weight of an aqueous polymer dispersion, from 1 to 15% by weight of the carboxylated tall oil resin colophony and from 15 to 55% by weight of filler.

3. The dispersion adhesive according to claim 1, further comprising a plasticizer.

4. The dispersion adhesive according to claim 3, wherein the plasticizer is selected from the group consisting of diethylene glycol dibenzoate and dipropylene glycol dibenzoate.

5. The dispersion adhesive according to claim 1, wherein the carboxylated tall oil resin colophony is present in an amount of from 1 to 30% by weight, based on the total weight of the adhesive.

6. The dispersion adhesive according to claim 1, wherein the carboxylated tall oil resin colophony is present in an amount of from 2 to 20% by weight, based on the total weight of the adhesive.

7. The dispersion adhesive according to claim 1, comprising less than 1% by weight, based on the total weight of the adhesive, of volatile organic compounds having a melting point of less than 150° C.

8. The dispersion adhesive according to claim 1, wherein the carboxylated tall oil resin colophony is the reaction product of a tall oil resin and an olefinically unsaturated carboxylic acid.

9. The dispersion adhesive according to claim 8, further comprising a disproportionation agent.

10. The dispersion adhesive according to claim 8, further comprising a polyol.

11. The dispersion adhesive according to claim 8, further comprising a neutralising agent.

12. The dispersion adhesive according to claim 8, wherein the olefinically unsaturated carboxylic acid is a dicarboxylic acid.

13. The dispersion adhesive according to claim 8, wherein the olefinically unsaturated carboxylic acid is selected from the group consisting of maleic acid, fumaric acid, and mixtures thereof.

14. The dispersion adhesive according to claim 1, wherein the water-dispersible polymer includes a polyacrylate-based polymer.

15. A process for producing a low-emission aqueous dispersion adhesive, comprising the step of mixing a carboxylated tall oil resin colophony with an aqueous polymer dispersion.

16. A process for preparing a tall oil resin derivative, comprising the steps of:
a) reacting a tall oil resin with an olefinically unsaturated carboxylic acid to form a reaction product,
b) adding a disproportionation agent to the reaction product,
c) adding a polyol to the reaction product, and
d) adding a neutralising agent to the reaction product.

17. A tall oil resin derivative prepared according to a process of claim 16.

18. A method for bonding a floor covering to a substrate, comprising applying an adhesive to one or more of the floor covering and the substrate and contacting the floor covering with the substrate, said adhesive comprising (1) an aqueous polymer dispersion comprising water and a water-dispersible polymer; and (2) a carboxylated tall oil resin colophony.

19. The method according to claim 18, wherein the floor covering is carpet.

20. The method according to claim 18, wherein said applying step comprises applying the adhesive to the substrate.
